(19) United States
(12) Patent Application Publication
(10) Pub. No.: US 2012/0234839 A1
(43) Pub. Date: Sep. 20, 2012

(54) COMPRESSED GAS INFLATOR WITH COMPOSITE OVERWRAP

(75) Inventors: Bradley W. Smith, Plain City, UT (US); Michael P. Jordan, South Weber, UT (US)

(73) Assignee: Autoliv ASP, Inc., Ogden, UT (US)

(21) Appl. No.: 13/051,840

(22) Filed: Mar. 18, 2011

(51) Int. Cl. F17C 1/00; B65H 81/02

(52) U.S. Cl. 220/581; 156/172

(57) ABSTRACT

An inflator device includes a steel member to at least in part form a pressure vessel and an external composite wrap overlying at least a portion of the metal member. The metal member can be tubular and have an elongated length such as to form a steel inner liner that is incapable of withstanding the pressure generated within the pressure vessel upon actuation of the inflator device without support provided by the composite overwrap.

### BACKGROUND OF THE INVENTION

This invention relates generally to the providing or supplying of inflation gas. More particularly, the invention relates to devices for providing or supplying an inflation gas such as may be desired for certain inflatable passive restraint systems for use in vehicles for restraining the movement of an occupant in the event of a vehicular collision as well as methods of forming or making such inflator devices.

It is well known to protect a vehicle occupant by means of safety restraint systems which self-actuate from an undeployed to a deployed state without the need for intervention by the operator, i.e., “passive restraint systems.” Such systems commonly contain or include an inflatable vehicle occupant restraint or element, such as in the form of a cushion or bag, commonly referred to as an “airbag cushion.” In practice, such airbag cushions are typically designed to inflate or expand with gas when the vehicle encounters a sudden deceleration, such as in the event of a collision. Such airbag cushions may desirably deploy into one or more locations within the vehicle between the occupant and certain parts of the vehicle interior, such as the doors, steering wheel, instrument panel or the like, to prevent or avoid the occupant from forcibly striking such parts of the vehicle interior. For example, typical or customary vehicular airbag cushion installation locations have included in the steering wheel, in the dashboard on the passenger side of a car, along the roof line of a vehicle such as above a vehicle door, and in the vehicle seat such as in the case of a seat-mounted airbag cushion. Other airbag cushions such as in the form of knee bolsters and overhead airbags also operate to protect other or particular various parts of the body from collision.

In addition to one or more airbag cushions, inflatable passive restraint system installations also typically include a gas generator, also commonly referred to as an “inflator.” Upon actuation, such an inflator device desirably serves to provide an inflation fluid, typically in the form of a gas, used to inflate an associated airbag cushion. Various types or forms of inflator devices have been disclosed in the art for use in inflating an inflatable restraint system airbag cushion.

One particularly common type or form of inflator device used in inflatable passive restraint systems is commonly referred to as a compressed gas inflator. In such inflator devices, gas used in the inflation of an associated inflatable element is derived from stored compressed gas.

One such conventional inflator device 20 is shown in FIG. 1. The inflator device 20 includes a closed pressure vessel gas storage chamber 22 at least in part formed by an elongated generally cylindrical sleeve 23 having a base end portion 24 and an opposing diffuser end portion 26. An initiator 30 is positioned at the base end portion 24 and a first burst disk 32 normally covers a base end opening 34 of the gas storage chamber 22 to prevent fluid communication between the initiator 30 and the gas storage chamber 22. A diffuser 40 is positioned at the opposing diffuser end portion 26 and a second or discharge end burst disk 42 normally covers a diffuser end portion 44 of the gas storage chamber 22 to prevent fluid communication between the gas storage chamber 22 and the diffuser 40. Upon actuation or activation of the initiator 30, the initiator 30 produces a discharge that ruptures the first burst disk 32 and heats a supply of compressed or pressurized gas stored within the gas storage chamber 22. As the supply of pressurized gas is heated, the internal pressure within the gas storage chamber 22 may be increased to an internal pressure level sufficient to rupture or otherwise open the second burst disk 42. Alternatively or in addition, a pressure wave may be created by the initiator 30 functioning and the breakage of the first burst disk 32 such as to rupture or otherwise open the second burst disk 42. Fluid communication between the gas storage chamber 22 and the diffuser 40 is provided or realized upon the opening of the second burst disk 42. The heated gas then exits the gas storage chamber 22 through the diffuser 40 to initiate deployment of an associated inflatable airbag cushion (not shown).

In such conventional inflator devices, the temperature and pressure within the gas storage chamber typically increases significantly during the initiation stage such as to provide an internal pressure sufficient to rupture the discharge end burst disk and permit gas flow from the storage chamber, through the diffuser and out to the associated inflatable airbag cushion. Thus, such inflator devices are commonly designed and constructed to have a sidewall of significant thickness to withstand the increase in internal pressure realized upon actuation of the inflator device. Unfortunately, increasing the thickness of the sidewall can result in inflator devices that are heavier and larger than desired.

Moreover, in reasonably long such pressure vessel housings having a cylindrical shape (e.g., where length is greater than diameter), the stress in the hoop direction is twice the stress in the axial direction.

Typically, compressed gas inflators include a pressure vessel housing designed so as to be able to withstand pressures in the range of 1.5 to 2 times the internal pressures created upon actuation of the compressed gas inflator, where such internal pressures are commonly at least 40 MPa up to 140 MPa, or more narrowly at least 55 MPa up to 120 MPa, or even more narrowly at least 65 MPa up to 110 MPa. In practice, such pressure vessels are typically elongated cylindrical in form and are made of steel of sufficient strength, i.e., thickness, to withstand the pressure within the vessel both during normal at-rest or pre-actuation state as well as upon actuation and functioning of the device. As detailed below, desired system design and operation typically involves or includes the addition or incorporation of an appropriate safety factor is tacked to the expected actual pressures.

The automotive industry continues to seek inflatable restraint systems that are smaller, lighter, and less expensive to manufacture. As industry constraints regarding factors such as the weight and size of vehicle components continue to evolve, corresponding changes to associated inflatable restraint systems are desired and required in order to better satisfy such constraints.

### SUMMARY OF THE INVENTION

The present invention provides improved compressed gas inflator devices as well as methods of or for making such compressed gas inflator devices.

In accordance with one aspect, there is provided an inflator device that includes a steel member to at least in part form a pressure vessel. An external composite wrap overlies at least a portion of the steel member. The composite wrap desirably is or includes a composite of fibers and a resin matrix system.

According to one embodiment, the steel member forms an inner liner that is, as further described below, incapable of withstanding the pressure generated within the pressure vessel upon actuation of the inflator device without support provided by the composite wrap.

In accordance with another embodiment there is provided an inflator device that includes a steel liner at least in part forming a pressure vessel. The inflator device also includes an external composite wrap overlying at least a portion of the steel liner. The composite wrap is or includes a composite of fibers and a resin matrix system. The steel liner is incapable of withstanding the pressure generated within the pressure vessel upon actuation of the inflator device without support provided by the overwrap. At functional pressures, the composite wrap and the steel liner share loading with the composite wrap subject to a proportionally larger amount of the total load at increasing functional pressures.

In another aspect, there is provided a method of making an inflator device. In one embodiment, the method involves providing a steel inner liner to at least in part form a pressure vessel. The steel inner liner is overwrapped with a composite of fibers and a resin matrix system. The composite overwrapped steel inner liner is treated to form an inflator device that withstands pressure generated within the pressure vessel upon actuation of the inflator device and wherein the steel inner liner is incapable of withstanding the pressure generated within the pressure vessel upon actuation of the inflator device without support provided by the composite overwrap.

As used herein, references to the ability or capability of an object or element such as an inflator, a liner or an overwrap to “withstand” a specified or designated pressure are to be understood as encompassing an appropriate safety factor. In practice, a typically appropriate suitable safety factor is 1.5 times the Maximum Expected Operating Pressure (“MEOP”).

Other objects and advantages will be apparent to those skilled in the art from the following detailed description taken in conjunction with the appended claims and drawings.

### BRIEF DESCRIPTION OF THE DRAWINGS

FIG. 1 is a simplified schematic side view, in section, of a prior art inflator device.

FIG. 2 is a simplified side view of an inflator device in accordance with one aspect of the invention.

FIG. 3 is a simplified side view of an inflator device in accordance with another aspect of the invention.

FIGS. 4-6 are graphical depictions of stress versus strain, hoop load portion versus internal pressure and internal pressure versus hoop strain, respectively, for showing load sharing of an inflator device in accordance with one aspect of the invention

FIG. 7 is a graphical depiction of burst pressure versus mass for the pressure vessels described in the Examples.

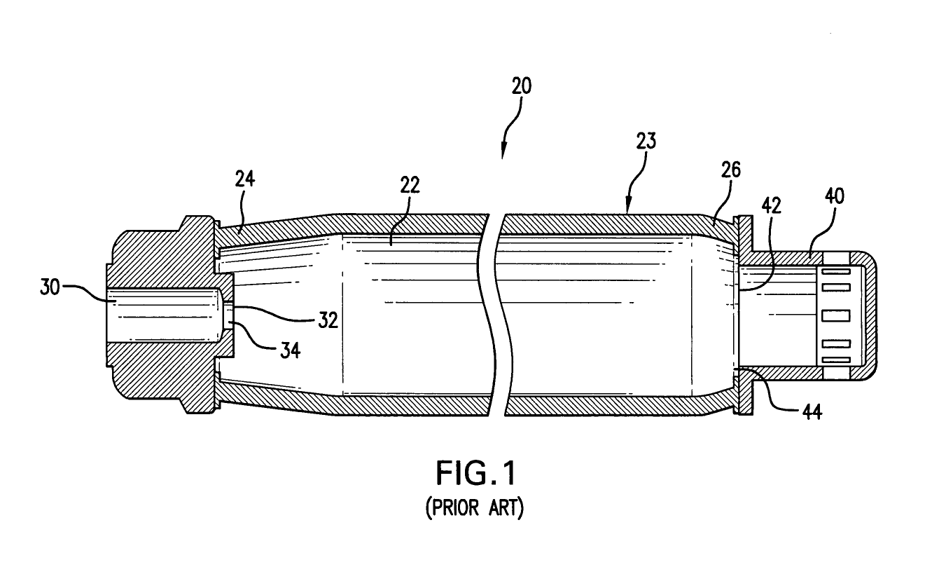

### DETAILED DESCRIPTION OF THE INVENTION

As described in greater detail below, the present invention provides improved compressed gas inflator devices as well as methods of or for making such compressed gas inflator devices.

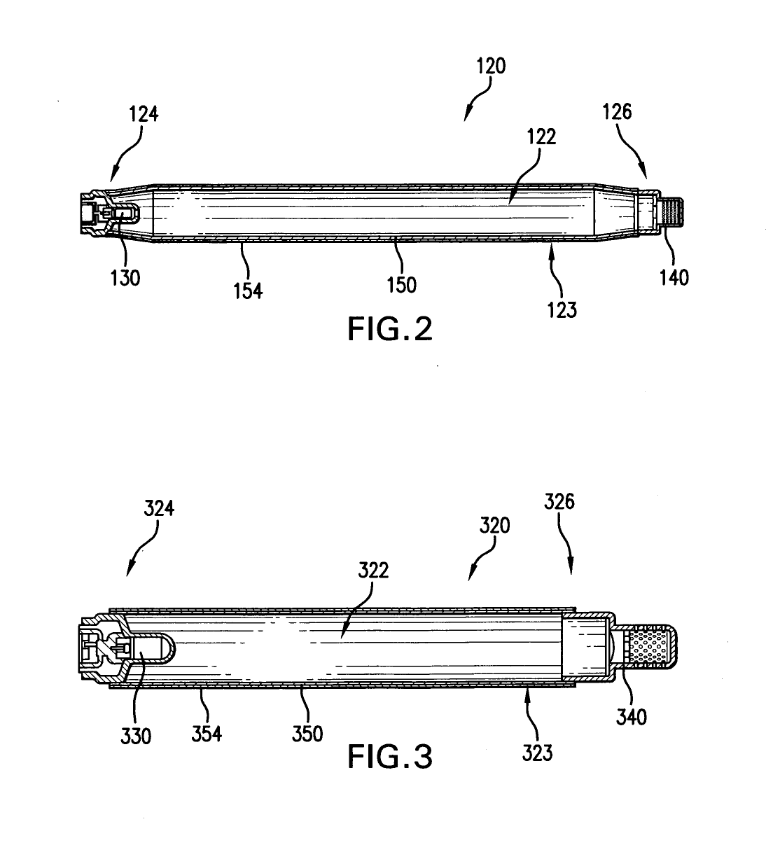

FIG. 2 illustrates an inflator device in accordance with one aspect of the invention and generally designated by the reference numeral 120. The inflator device 120 is somewhat similar to the inflator device 20 described above in that it includes a pressure vessel gas storage chamber 122 at least in part formed by an elongated generally cylindrical sleeve 123 having a base end portion 124 and an opposing diffuser end portion 126. An initiator 130 is disposed or positioned at the base end portion 124 and a diffuser 140 is disposed or positioned at the opposing diffuser end portion 126.

As will be appreciated, the inflator device 120 may include or contain burst disks (not here shown) or other features, such as known in the art, to prevent fluid communication between the gas storage chamber 122 and the initiator 130 and diffuser 140, respectively, when the inflator device is in an at rest or pre-actuation state or condition and such as may rupture or otherwise permit such fluid communication upon actuation of the inflator device.

The inflator device 120 differs from the inflator device 20 in that the elongated generally cylindrical sleeve 123 rather being entirely made of steel for required strength is composed of an inner steel liner 150 and an external composite wrap 154 overlying at least a portion of the inner steel liner 150.

As will be described in greater detail below, the inner steel liner 150 can desirably be fabricated or formed of a steel material, such as a low carbon, heat-treatable steel, for example, wherein the steel is relatively thin as compared to conventional compressed gas pressure vessel housings. As inflator devices and, more specifically, the pressure vessel portions of such inflator devices in accordance with certain aspects of the invention can desirably be fabricated for single use application the thickness of the inner steel liner of an inflator device as herein described can desirably be reduced to between 75% and 40% of that of a conventional all steel compressed gas inflator pressure vessel housing. For example, whereas current all steel compressed gas inflator pressure vessel housings have wall thicknesses typically in a range of between 2.5 mm and 1.8 mm, a composite inflator device as herein described can advantageously have a steel wall thickness reduced to a range of 0.9 mm to 1.4 mm.

The inner steel liner 150 can desirably provide required gas tightness to the inflator device 120.

A high pressure capable single use structure can desirably be created or formed by overwrapping the steel inner liner 150 with a selected material such as having the form of a composite.

Overwrap processing in accordance with one aspect of the invention generally involves filament winding a composite material, such as composed of high strength fibers and a resin matrix system, around, about and/or over the inner liner 150 to form an overwrap thickness about the inner liner. It is noted that the inflator device 120 has one or more end portions, e.g., the base end portion 124 and the diffuser end portion 126 that are swaged. Filament winding of the composite material as herein described facilitates and permits application of such composite materials onto such swaged end portions.

The composite overwrapped liner can subsequently be treated or cured to form an inflator device that withstands the pressure generated within the gas storage chamber such as upon actuation of the inflator device such as during the initiation stage. In particular, such an inflator device with such a composite overwrapped liner can desirably withstand the pressure generated within the gas storage chamber such as upon actuation of the inflator device such as during the initiation stage wherein the steel inner liner is incapable of withstanding such generated pressures without support provided by the composite overwrap.

Various fiber materials such as known in the art can be used. For improved economics, in certain embodiment the use of relatively inexpensive fiber materials, such as glass fiber or basalt fiber materials, are preferred. In particular, inflator devices such as herein described permit the use of comparatively inexpensive fiber materials such as glass or basalt in conjunct with liners such as made of steel as the elastic or Young's Modulus of the fiber and the steel need not have the same value (i.e., the Young's Modulus of the steel is lower than that for glass). As described in greater detail below, with an inflator device as herein described in accordance with certain aspects of the invention, when the steel inner liner stretches, the glass fibers can desirably stretch at the same strain rate and because of the stretch of the steel of the liner before failure, the composite overwrap will assume a larger portion of the load.

More specifically, the steel liner can desirably be designed such that for normal storage pressures, the liner can safely contain or carry pressure loads in the elastic material range. At higher pressures, such as may be needed to demonstrate a desired safety factor, the steel inner liner is allowed to yield, e.g., “balloon”, such that the composite overwrap material develops at least in part and, in some embodiments, its full load carrying potential. As the overall load is increased such as upon actuation and deployment of the inflator device, the loading of the lower modulus material (e.g., glass composite) is increased due to the leveling of the load carrying capability of the steel liner as it yields.

Processing times can desirably be reduced or minimized by utilizing a UV cure resin system instead of common thermoset, elevated temperature cure resin systems. For example, a typical elevated temperature cure cycle involves heating at 120° C. for 90 minutes, while a UV cure system can effect cure in under 15 seconds when using a UV permeable fiber such as E-glass.

UV curing has the additional safety advantage of avoiding subjecting the device being cured to elevated temperatures such as may serve or act to stress or otherwise deteriorate burst disks or like features or elements contained within the inflator devices as well as reducing the likelihood of degradation of pyrotechnic or other reactant materials contained within the device. In addition, such cure processing can advantageous facilitate product handling during the manufacture process.

While certain aspects of the invention have been described above making specific reference to UV curing and the use of UV curable resins, those skilled in the art and guided by the teachings herein provided will appreciate that the broader practice of the invention is not necessarily so limited. For example, other types of resins and other associated treatment or curing techniques, including other forms of radiation curable resins and radiation curing can be used as may be desired for particular applications.

Specific other types of resins and treatment techniques useable in the practice of the invention can include: thermoset resins such as are heat curable and thermoplastic resins such as curable or treatable via local melting, for example. One specific example of such other type of resin is a thermoplastic resin such as may desirably be used in conjunction with primarily unidirectional fibers, e.g., E-glass fibers, such as to form a sheet of preimpregnated, primarily unidirectional fibers. Such a sheet can be treated such as by heating one side of the material as it is wrapped onto an underlying steel member such as in the form of a tube or an inflator tubular structure. Suitable heating methods for such a material, dependent on particular applications can include an open flame (torch), IR lamps, heat gun, or the like.

Through the incorporation and use of such composite materials, the mass of a compressed gas inflator device can desirably be reduced by decreasing the amount, mass and/or thickness of metal, e.g., steel, such as used in forming the pressure vessel or chamber.

While the invention has been described above making reference to embodiments wherein overwrap processing generally involves filament winding a composite material, such as composed of high strength fibers and a resin matrix system, around, about and/or over a steel liner that at least in part forms a pressure vessel, the broader practice of the invention is not necessarily so limited.

For example, if desired, the composite material can alternatively be wound around, about and/or over a mandrel so as to form a tube of composite overwrap that can be applied onto a steel member such as at least in part forms a pressure vessel. Such a composite overwrap tube can be applied onto a steel member such as by sliding and/or pressing the composite overwrap tube onto an underlying steel liner, for example.

Alternatively, such as for improved or facilitated manufacture, composite material can be wound around, about, and/or over steel tubes of extended lengths, such as 5 to 15 meter lengths, for example, and subsequently processed, e.g., cut or other processed, to form composite overwrapped steel tubes in length or lengths required for application in inflator assembly. Such length of composite overwrapped steel tube can subsequently be joined with a base and diffuser to form an inflator assembly.

FIG. 3 illustrates an inflator device generally designated by the reference numeral 320. The inflator device 320 is somewhat similar to the inflator device 120 described above in that it includes a pressure vessel gas storage chamber 322 at least in part formed by an elongated generally cylindrical sleeve 323 having a base end portion 324 and an opposing diffuser end portion 326. An initiator 330 is disposed or positioned at the base end portion 324 and a diffuser 340 is disposed or positioned at the opposing diffuser end portion 326.

As will be appreciated, the inflator device 320 may include or contain burst disks (not here shown) or other features, such as known in the art, to prevent fluid communication between the gas storage chamber 322 and the initiator 330 and diffuser 340, respectively, when the inflator device is in an at rest or pre-actuation state or condition and such as may rupture or otherwise permit such fluid communication upon actuation of the inflator device.

The inflator device 320 differs from the inflator device 120 in that rather than filament winding of a composite onto the structure, an external composite wrap tube 354 has been applied onto the inner steel line 350 such as to overly at least a portion of the inner steel liner 350 such as in a fashion as described above.

While the invention has been described above making reference to embodiments wherein a liner, such as made of steel, is a tubular member having an elongated length and the external composite wrap overlies at least a substantial portion of the elongated length of the tubular member steel liner, those skilled in the art and guided by the teachings herein provided will appreciate that the broader practice of the invention is not necessarily so limited.

In accordance with another aspect of the invention, there is provided methods for making inflator devices. One such method involves making or otherwise providing a pressure vessel formed at least in part by a steel inner liner. The steel inner liner can then be appropriately overwrapped with a composite of fibers and a resin matrix system, such as described above. The composite overwrapped steel inner liner can then be treated to form an inflator device that withstands the pressure generated within the pressure vessel upon actuation of the inflator device and wherein the steel inner liner is incapable of withstanding the pressure generated within the pressure vessel upon actuation of the inflator device without support provided by the composite overwrap.

As described above, a preferred technique for effecting such cure in accordance with one aspect of the invention is through the incorporation of a UV curing agent in the composite resin system and subsequent UV-curing of the composite overwrapped metal liner.

While the broader practice of the invention is not necessarily limited by whether gas fill of the pressure vessel formed by the steel member occurs before or after application of the external composite wrap those skilled in the art and guided by the teachings herein provided will appreciate that for certain particular applications it may be desirable to fill the pressure vessel prior to application of the composite overwrap while for other particular applications it may be desired to fill the pressure vessel after application of the composite overwrap. For example, as the application and treatment of the external composite wrap can act to heat the underlying steel member and, in the case of a pressure vessel, any contents therein contained, it may be desired to apply and treat the external composite wrap prior to gas fill of the pressure vessel. On the other hand, sequencing gas fill prior to the application and treatment of the external composite wrap can facilitate manufacture and production such as by facilitating or simplifying leak check of the pressure vessel as, for example, the composite overwrap can act to mask leakage or otherwise store or conceal leaked gas such as during a vacuum phase of leak check of the device and lead to virtual leaks or longer time periods required perform the suitable product leak checks.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

### Example 1

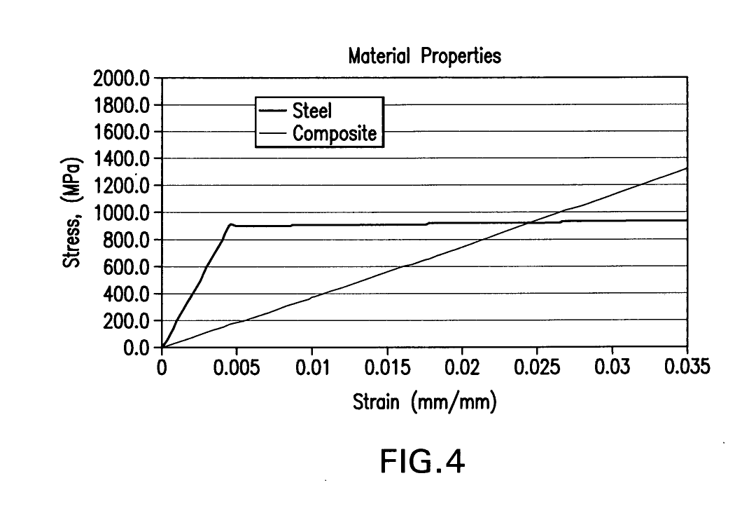

The following hypothetical example illustrates the load sharing for an inflator structure of an inner steel tube and an outer composite overwrap such as herein described. The idealized material properties for this case are shown in FIG. 4. In this example, the tubular inflator structure is a steel tube with an inside diameter of 31.5 mm and a wall thickness of 1 mm. The Elastic (Young's) modulus of the steel is 200 GPa. The composite overwrap is composed of a hoop fiber overwrap with an Elastic (Young's) modulus of 37 GPa and a thickness of 1.25 mm. The steel is shown to yield at 900 MPa. After yield, the steel is shown to carry only a very slight increase in stress as the strain increases. The composite overwrap does not yield until failure.

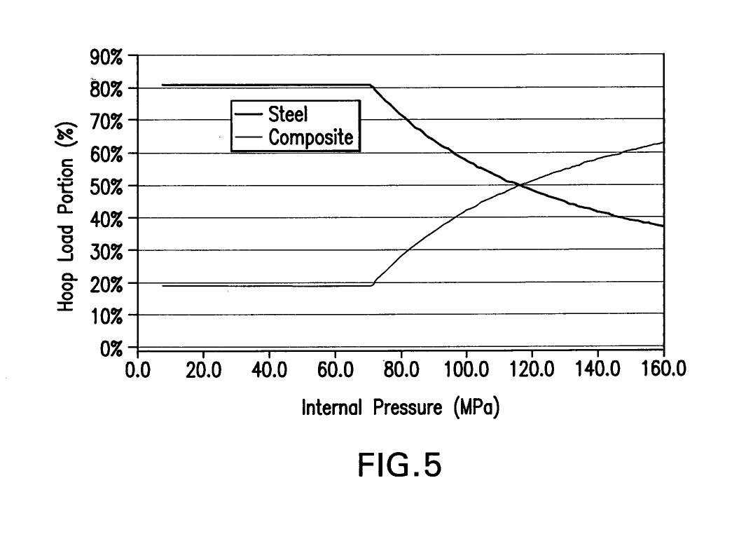

In FIG. 5, the load sharing between the composite overwrap and the steel liner is demonstrated for this same example. As shown in FIG. 5, the steel yields at approximately 70 MPA internal pressure (within the cylinder). This yield point corresponds to the 900 MPa stress in the steel shown in FIG. 4. After yielding, the steel cannot carry significant additional loading and the steel liner is shown as carrying a decreasing proportion of the load as the total load (i.e., the internal pressure) continues to increase. However, as the total load (i.e., the internal pressure) continues to increase, the composite proportionally carries a greater portion of the increase in loading. This continues until the capability for elongation of the steel or the ultimate strength of the composite is exceeded at which point the structure fails.

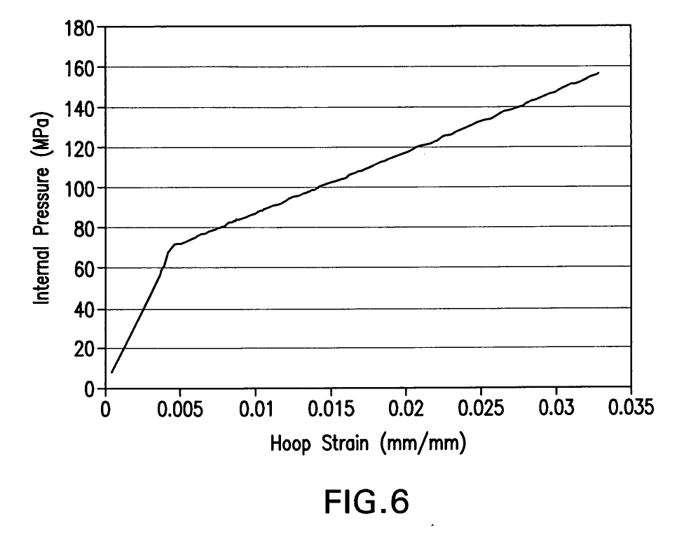

FIG. 6 provides additional information concerning the behavior of the overall structure in this example. At approximately 70 MPA internal pressure in the tube, the steel yields. After the steel yields, the strain on the structure increases at a faster rate for a corresponding increase in internal pressure than before the yielding of the steel and the composite overwrap, having a lower modulus, carries more of the load. This continues until failure at the point where the overall load carrying capability of the structure is exceeded.

### Example 2

Using tubular steel pressure vessels having a 35 mm outer diameter and a starting wall thickness of 2.5 mm, a series of testing was done to assess the feasibility of weight reduction of the pressure vessel by reducing the steel wall thickness and providing a composite overwrap of glass fiber (e.g., E-glass) and resin reinforcement. Selected pressure vessels were machined to 1.0 mm and 1.25 mm remaining wall thickness. The pressure vessels were wrapped with 4, 5, and 6 layers of wet wound E-glass. Burst test were conducted on the finished pressure vessels.

A fiber-wrapped pressure vessel of 1.0 mm remaining steel wall thickness and a fiber-wrapped pressure vessel of 1.25 mm remaining steel wall thickness failed axially at the end of the machined section at 1089 bar and 1239 bar, respectively.

Subsequently, in order to better permit a test of the capability of the glass overwrapped tubular steel member, an axial support fixture was provided so that the pressure vessels were axially supported during the testing such that burst failure of the pressure vessels occurred in the composite overwrap region of the pressure vessels.

### Results and Conclusions

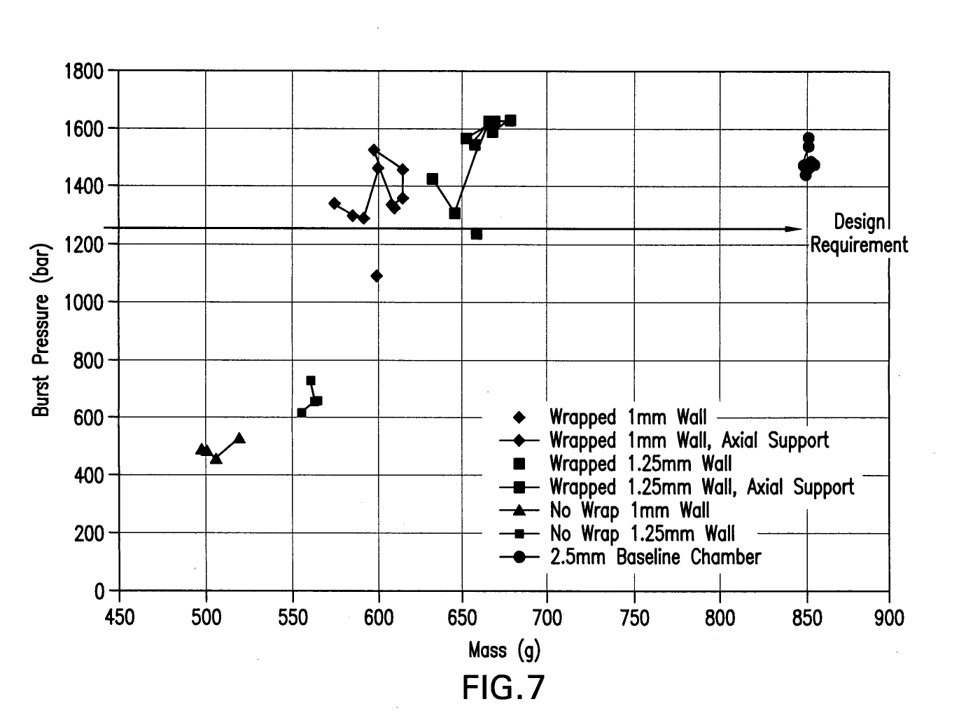

FIG. 7 graphically depicts burst pressure versus mass for the pressure vessels tested in the series of the Example 2 testing.

The testing shows the potential to achieve burst values acceptable for inflator internal pressures or equivalent to those obtained from all steel structures with significant mass reductions.

Analysis of the results indicates that 35 mm burst requirements can be met with 33.5 mm OD×1.0 mm thick wall, heat-treated tubing, overwrapped with approximately 1.25 mm of glass fiber reinforcement.

Subsequent testing has included testing with production parts including a 1.1 mm metal wall thickness, wrapped with 1.5 mm thickness of composite overwrap. The burst values obtained in this subsequent testing has confirmed the earlier experimental results, e.g., the burst values realized with this configuration were greater than 1250 bar and the inflator was still lighter than a conventional all steel structure.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An inflator device comprising:
a steel member to at least in part form a pressure vessel and
an external composite wrap overlying at least a portion of the steel member, the composite wrap comprising a composite of fibers and a resin matrix system.

2. The inflator device of claim 1 wherein the composite fibers comprise glass or basalt fibers.

3. The inflator device of claim 1 wherein the steel member forms an inner liner incapable of withstanding the pressure generated within the pressure vessel upon actuation of the inflator device without support provided by the composite wrap.

4. The inflator device of claim 1 wherein the resin matrix system comprises a radiation curable resin.

5. The inflator device of claim 4 wherein the radiation curable resin is a UV curable resin.

6. The inflator device of claim 1 wherein the resin matrix system comprises a heat curable thermoset resin.

7. The inflator device of claim 1 wherein the resin matrix system comprises a thermoplastic resin curable via local melting.

8. The inflator device of claim 1 wherein the steel member is tubular, has an elongated length and forms an inner liner and the external composite wrap overlies at least a substantial portion of the elongated length of the tubular steel member.

9. The inflator device of claim 8 wherein the steel inner liner is incapable of withstanding the pressure generated within the pressure vessel upon actuation of the inflator device without support provided by the overwrap.

10. The inflator device of claim 8 wherein the external composite wrap comprises a premade tube of the fibers and the resin matrix, with the premade tube applied onto the tubular steel member.

11. The inflator device of claim 8 wherein the external composite wrap comprises a sheet of preimpregnated, primarily unidirectional fibers wrapped about the tubular steel member.

12. The inflator device of claim 8 wherein the external composite wrap comprises a winding of the composite about the tubular steel member.

13. An inflator device comprising:
a steel liner at least in part forming a pressure vessel and
an external composite wrap overlying at least a portion of the steel liner, the composite wrap comprising a composite of fibers and a resin matrix system;
wherein the steel liner is incapable of withstanding the pressure generated within the pressure vessel upon actuation of the inflator device without support provided by the composite wrap and
wherein at functional pressures the composite wrap and the steel liner share loading with the composite wrap subject to a proportionally larger amount of the total load at increasing functional pressures.

14. The inflator device of claim 13 wherein the composite fibers comprise glass fibers.

15. The inflator device of claim 13 wherein the composite fibers comprise basalt fibers.

16. The inflator device of claim 13 wherein the resin matrix system comprises a UV curable resin.

17. The inflator device of claim 13 wherein the steel liner is a tubular member having an elongated length and the external composite wrap overlies at least a substantial portion of the elongated length of the tubular member steel liner.

18. A method of making an inflator device, the method comprising:
providing a steel inner liner to at least in part form a pressure vessel;
overwrapping the steel inner liner with a composite of fibers and a resin matrix system; and
treating the composite overwrapped steel inner liner to form an inflator device that withstands the pressure generated within the pressure vessel upon actuation of the inflator device and wherein the steel inner liner is incapable of withstanding the pressure generated within the pressure vessel upon actuation of the inflator device without support provided by the composite overwrap.

19. The method of claim 18 wherein the resin is UV curable and said treating the composite overwrapped steel inner liner comprises UV curing the composite overwrapped metal inner liner.

20. The method of claim 18 wherein the resin is a heat curable thermoset resin and said treating the composite overwrapped steel inner liner comprises heat curing the composite overwrapped metal inner liner.

21. The method of claim 18 wherein the resin is a thermoplastic resin curable via local melting and said treating the composite overwrapped steel inner liner comprises locally melting the composite overwrapped metal inner liner.

22. The method of claim 18 wherein the overwrapping of the steel inner liner with a composite of fibers and a resin matrix system comprises applying a premade tube of the fibers and the resin matrix onto the steel inner liner.

23. The method of claim 18 wherein the overwrapping of the steel inner liner with a composite of fibers and a resin matrix system comprises winding the composite about the steel inner liner.
